(19) United States
(12) Patent Application Publication
(10) Pub. No.: US 2013/0302102 A1
(43) Pub. Date: Nov. 14, 2013

(54) Bore Cutting Tool and Method of Making the Same

(71) Applicants: Jamie Green, Wakefield (GB); David Goulbourne, Sheffield (GB)

(72) Inventors: Jamie Green, Wakefield (GB); David Goulbourne, Sheffield (GB)

(73) Assignee: SANDVIK INTELLECTUAL PROPERTY AB, Sandviken (SE)

(21) Appl. No.: 13/821,354

(22) PCT Filed: Sep. 5, 2011
(86) PCT No.: PCT/GB11/01304

§ 371 Date: Apr. 11, 2013

(30) Foreign Application Priority Data
Sep. 8, 2010 (GB) 1014966.4

(51) Int. Cl. B23B 51/02; B23P 15/32

(52) U.S. Cl. CPC B23B 51/02; B23P 15/32
USPC 408/144; 408/199; 29/527.4; 76/108.6

(57) ABSTRACT

A bore cutting tool, particularly for cutting metal workpieces, includes a tool substrate and a tool coating on a surface of the tool substrate. The bore cutting tool comprises a plurality of pits in the surface of the tool substrate and wherein the tool coating extends over the pits such that the pit surface comprises the tool coating. In this way, the pit dimensions can be retained over prolonged tool life and the pits, with their coated surface, are particularly effective at retaining lubricant so that the thickness of a lubricant film can be increased as compared to a tool without the coated pits. In embodiments the pits are formed by laser etching and are present only on the cylindrical land. Average pit depth is suitably in the range 8 μm to 25 μm, average pit width and pit length is independently selected from 40 μm to 250 μm and average pit density is 20 to 30 pits/mm².

The present invention relates to bore cutting tools and methods of making such bore cutting tools, in particular such bore cutting tools for metal workpieces, and in particular twist drills.

One of the major influences in tool life when machining metals is the lubrication (also referred to as coolant) applied. If a machining process is run ‘dry’ (without lubrication) the tool life is dramatically reduced when compared to a machining process which has lubrication present.

This is because the lubrication reduces the ‘μ’ value (coefficient of friction) between the surfaces of contact, i.e. tool and workpiece. Reducing the value of μ leads to a reduction in friction between the contactable surfaces, which consequently leads to a reduction in tool wear and heat generation.

There are four basic forms of lubrication: Hydrodynamic lubrication, where two sliding surfaces are separated by a film of liquid which is held between them by local pressure; elastohydrodynamic lubrication, where two sliding surfaces are separated by a very thin film of fluid which is held between them by higher forms local pressure; mixed lubrication, where two surfaces are partly separated by a liquid film and partly in contact with each other; and boundary lubrication, where two surfaces are mostly in contact with each other, even though there is a fluid present. In boundary lubrication, it is believed that the film thickness between the two surfaces is in the range 0.001 to 0.05 μm [Dwyer-Joyce, R. S (1995) The Tribology Group Institution of Mechanical Engineers, ‘Tribological Design Data Part 2: Lubrication’, 2, 10]

It is understood that during metal machining with a bore cutting tool, such as drilling, the type of lubrication present is boundary lubrication where the two surfaces are mostly in contact with each other with very little lubricating fluid.

Accelerated tool wear caused by inefficient lubrication can give rise to reduced tool performance, for example poor hole reproducibility.

Ideally, in order to reduce tool wear the film thickness needs to be increased between the two surfaces, for example the cylindrical land and the workpiece. Theoretically this will reduce the value of μ at the point of contact between the two surfaces. However, an increase in film thickness is difficult to achieve

Embodiments of the present invention address the drawbacks discussed above. The present inventors have surprisingly found that existing levels of lubricant usage can be retained whilst improving the lubricating effect. That is, without necessarily increasing the amount of lubricant used during a cutting process, improvements in tool wear can be achieved.

At its most general, the present invention proposes that a bore cutting tool is provided with a plurality of pits in a surface of the bore cutting tool wherein a coating is applied over the pits, for retaining lubricant at the surface during use.

In a first aspect, the present invention provides a bore cutting tool comprising
a tool substrate; and
a tool coating on a surface of the tool substrate

wherein the bore cutting tool comprises a plurality of pits in the surface of the tool substrate and wherein the tool coating extends over the pits such that the pit surface comprises the tool coating.

The present inventors have found that excellent performance can be achieved by providing a pit that is formed in the tool substrate and then coated, rather than a pit formed in the coating. Indeed, in experiments, the present inventors found that pits formed after coating, for example by laser etching into the coating, caused damage to the coating in the area around the pit. For example, significant cracking of the coating was observed some distance from the pit. This can lead to premature tool failure. Furthermore, uneven and inconsistent pit dimensions were produced.

A further advantage of the coated pit structure of embodiments of the present invention is that the properties of the coating are retained in respect of the surface of the tool between the pits, right up to the periphery of a pit. Furthermore, the advantageous properties of the coating are also provided to the pits themselves because the coating follows the contours of the pits. FIG. 1 illustrates a typical pit in cross-section, showing the coating extending over the pit surface so as to provide the coating as the pit surface.

With regard to the coating of the pits, the present inventors have found that whilst some variation of the coating thickness may be observed in and around the pits (which variation might be attributable to the known corner and edge effects associated with deposition of coatings onto drill geometries), the pits are effectively provided with a coating such that the surface of the pits (i.e. the inner surface of the pits) comprises coating material. In embodiments this assists in retaining the pit dimensions over prolonged tool life.

A further advantage is that a comparatively smooth pit surface can be achieved by virtue of the coating applied to the pit.

The present inventors have found that the pits, with their coated surface, are particularly effective at retaining lubricant, for example acting as reservoirs for the lubricant.

In embodiments of the present invention, the thickness of the lubricant film can be increased as compared to a bore cutting tool without the pits.

Suitably this generates areas of hydrodynamic lubrication where the fluid is forced into the pits as the tool surface comes into contact with the workpiece.

Preferably the average pit depth is at least 5 μm, more preferably at least 8 μm. Suitably the average pit depth is no more than 50 μm, preferably no more than 25 μm and most preferably no more than 15 μm. A particularly preferred average pit depth is in the range 8 μm to 25 μm. Average pit depth can be measured using white light interferometry as discussed herein.

Suitably the average pit width and average pit length are independently selected from 20 μm to 400 μm, more preferably 40 μm to 250 μm. In the case of circular pits, the diameter is of course the width and length. Average pit width and average pit length can be measured using white light interferometry.

Suitably the average pit cross-sectional area is in the range 0.005 mm² to 1 mm². Again, this can be measured using white light interferometry.

Suitably the average pitch (centre to centre spacing) is in the range 50 μm to 350 μm, preferably 50 μm to 250 μm, more preferably 50 μm to 150 μm. Again, this can be measured using white light interferometry or SEM.

Suitably the average density of the pits is in the range 5 to 50 pits/mm², preferably 20 to 30 pits/mm² with about 24 pits/mm² being preferred.

The pits can be any suitable shape, for example elongate (e.g. round ended or round cornered rectangles), circular, triangular or rectangular. It is preferred that the pits are round ended or round cornered rectangles, also referred to herein as slot-shaped pits or slots.

Suitably the plurality of pits are an array of pits. That is, the plurality of pits are suitably arranged in a non-random pattern. Suitably the spacing between adjacent pits is the same for at least the majority of, preferably substantially all of, the pits in the array. Preferably the pits are arranged as a plurality of rows of pits, suitably with substantially equal spacing between the rows. A grid pattern is particularly preferred.

Suitably the plurality of pits are present only on at least one surface of the bore cutting tool which in use is in frictional contact with the workpiece. As explained herein, a preferred bore cutting tool is a twist drill and in twist drill embodiments the twist drill has a cylindrical land and the plurality of pits is present only on the cylindrical land. Suitably at least 50% of the cylindrical land is provided with pits, preferably substantially all of the cylindrical land is provided with pits. The present inventors have found that by providing pits on the cylindrical land of a twist drill, considerable improvements in tool performance can be achieved, as discussed in the examples herein.

Preferably the tool coating has an average thickness of at least 0.5 μm, more preferably at least 1 μm. Suitably an upper limit for the average thickness is 10 μm, preferably 5 μm. A preferred coating thickness is in the range 1 μm to 5 μm.

The bore cutting tool can be partially or fully coated. Preferably the coating is a wear resistant coating, suitably having a lower coefficient of friction than the uncoated tool.

Suitable coatings include metal nitride based coating (e.g. TiN, AlxTiyN, etc.), metal oxide based coating (e.g. AlxO, AlxCryO, etc.), carbon based coating (e.g. DLC, Diamond Coating, etc.) and combinations thereof. Preferably the tool coating comprises a nitride coating, suitably a metal nitride based coating, more preferably TiAlN.

Suitable coating methods include vapour deposition, for example physical vapour deposition (PVD), or other vacuum deposition techniques, and chemical vapour deposition (CVD).

The pits can suitably be created by a laser or electron beam. For convenience, the preferred use of a laser is discussed herein but this should be understood to also be a reference to use of an electron beam. Suitably the pits are formed by laser etching of the tool substrate prior to forming the tool coating. For example, laser etching systems used for marking metal components can be applied to bore cutting tools to produce the desired plurality of pits.

The desired pattern of the array is programmed into the laser controller and the laser is then operated so as to provide the cutting tool with the pits according to that pattern.

Typically, the laser is moved with respect to the tool (or blank). Suitably the tool or blank is rotated. Alternatively or additionally the laser source is moved over the surface of the tool.

Preferably the bore cutting tool is a round tool. Suitably the bore cutting tool is selected from a twist drill, an end mill, a reamer and a tap. Preferably the bore cutting tool is a twist drill. Suitably the twist drill is a metal working twist drill.

Whilst the bore cutting tool (e.g. twist drill) is generally for cutting metal workpieces, it can also be adapted for other workpiece materials such as composites and ceramics.

Preferably the tool substrate is made of carbide. A preferred carbide is tungsten carbide. Alternative materials include high speed steel (HSS), HSCo and HSCoXP, silicon nitride and PCD (polycrystalline diamond), or combinations thereof (for example PCD mounted on a metal body).

In a further aspect the present invention provides a method of making a bore cutting tool having a plurality of pits on a surface of the bore cutting tool, the method comprising the steps of forming a plurality of pits in the surface of a tool substrate, and coating the pitted surface of the tool substrate to form a tool coating.

The preferred pit dimensions, pit geometry and pattern of pits discussed above with respect to the first aspect also apply to this aspect as method steps of forming the pits.

Similarly, it is preferred that the method is a method of making a twist drill.

Suitably the step of forming pits is a step of forming pits by laser etching of the tool substrate.

Suitably the step of forming the plurality of pits comprises forming pits in a tool blank and machining the blank to form the tool substrate.

Suitably the method includes the step of cleaning the surface in which the pits are formed, for example to remove flash. Preferably the cleaning step comprises an outer diameter grind.

In a further aspect, the present invention provides a method of making a bore cutting tool having a plurality of pits in a surface of the bore cutting tool, the method comprising the steps of forming the plurality of pits in a surface of a bore cutting tool blank, and machining the blank to form the bore cutting tool.

The preferred pit dimensions, pit geometry and pattern of pits discussed above with respect to the first aspect also apply to this aspect as method steps of forming the pits.

Suitably the method includes the step of cleaning the surface in which the pits are formed, for example to remove flash. Preferably the cleaning step comprises an outer diameter grind.

Suitably the method includes the step of coating the bore cutting tool to form a tool coating.

Suitably the bore cutting tool is a twist drill and the step of machining the blank includes machining at least one flute. Suitably the bore cutting tool is a twist drill having a cylindrical land, and the step of machining the blank includes machining the blank so as to provide the cylindrical land, which cylindrical land comprises a plurality of pits.

As with the previous aspect, it is preferred that the pits are formed by laser etching.

A particularly preferred method for making a coated bore cutting tool comprising pits in a surface of the tool is as follows:

(1) Grind the tool rods (e.g. carbide rods) to the required tool (e.g. drill) blank geometry;

(2) Apply the required pit pattern to the blank (e.g. using a laser);

(3) Remove flash generated in step (2)

(4) Grind the patterned blank to the required tool geometry ensuring the desired patterned area remains present; and

(5) Coat the tool with the required coating (e.g. by vapour deposition).

In a further aspect, the present invention provides a method of making a bore cutting tool having a plurality of pits in a surface of the bore cutting tool, the method comprising the step of forming the plurality of pits using a laser.

The preferred pit dimensions, pit geometry and pattern of pits discussed above with respect to the first aspect also apply to this aspect as method steps of forming the pits.

Suitably the method includes the step of cleaning the surface in which the pits are formed, for example to remove flash. Preferably the cleaning step comprises an outer diameter grind.

In a further aspect, the present invention provides a method of making a bore cutting tool having a plurality of pits in a surface of the bore cutting tool, the method comprising the steps of forming an array of pits in the surface of the bore cutting tool.

In embodiments, a regular pattern (array) of pits rather than a random pattern may enable a smaller area to contain more coolant reservoirs, thus generating increased areas of hydrodynamic lubrication. In embodiments, this may reduce the average μ of the surfaces in contact thus reducing the wear experienced by the tool leading to extended tool life and improved hole quality.

The preferred pit dimensions, pit geometry and pattern of pits discussed above with respect to the first aspect also apply to this aspect as method steps of forming the pits.

Suitably the step of forming the pits includes forming the pits using a laser.

Suitably the method includes the step of cleaning the surface in which the pits are formed, for example to remove flash. Preferably the cleaning step comprises an outer diameter grind.

Preferably the array of pits comprises a plurality of regularly spaced rows of pits.

In a further aspect, the present invention provides a bore cutting tool comprising an array of pits in the surface of the bore cutting tool.

The preferred pit dimensions, pit geometry and pattern of pits discussed above with respect to the first aspect also apply to this aspect as method steps of forming the pits.

Suitably the array of pits comprises a plurality of regularly spaced rows of pits.

In a further aspect, the present invention provides a use of a laser to form a plurality of pits in a bore cutting tool.

In a further aspect, the present invention provides a method of coating a bore cutting tool, wherein the bore cutting tool comprises a plurality of pits in a surface of the bore cutting tool such that the coating is applied to the pitted surface.

In a further aspect, the present invention provides a method of cutting a workpiece using a bore cutting tool as described herein.

Preferably the workpiece is a metal workpiece, preferably a titanium or titanium alloy workpiece, for example AMG 4.3 (Ti-6 Al-4V).

Preferably the bore cutting tool is a twist drill and the method is a method of drilling a workpiece.

Preferably the method includes applying lubrication, suitably minimum quantity lubrication (MQL). The present inventors have found that the application of a plurality of pits to a bore cutting tool as described herein can bring particular benefits when MQL is used by optimising the comparatively small amounts of lubricant that are used.

In a further aspect, the present invention provides a bore cutting tool made by any one of the methods disclosed herein.

Any one of the aspects of the present invention may be combined with any one or more of the other aspects. Furthermore, any of the optional or preferred features of any one of the aspects may apply to any of the other aspects.

In particular, optional features associated with a method or use may apply to a product, and vice versa.

Embodiments of the present invention will now be described with reference to the accompanying figures, in which:

FIG. 1 shows a cross-section of a pit comprising a coated surface;

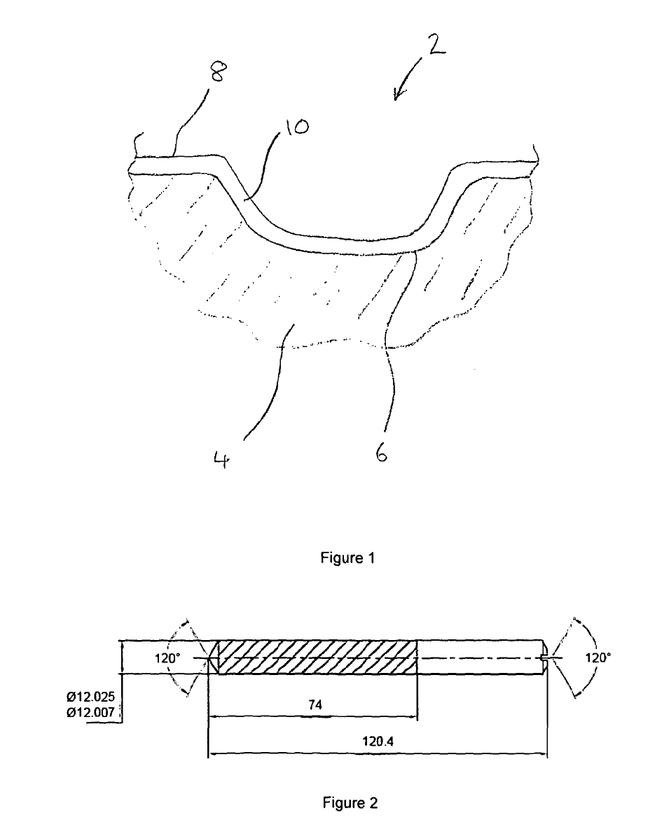

FIG. 2 shows a tool blank (twist drill blank) to which an array of pits is applied in the hatched area;

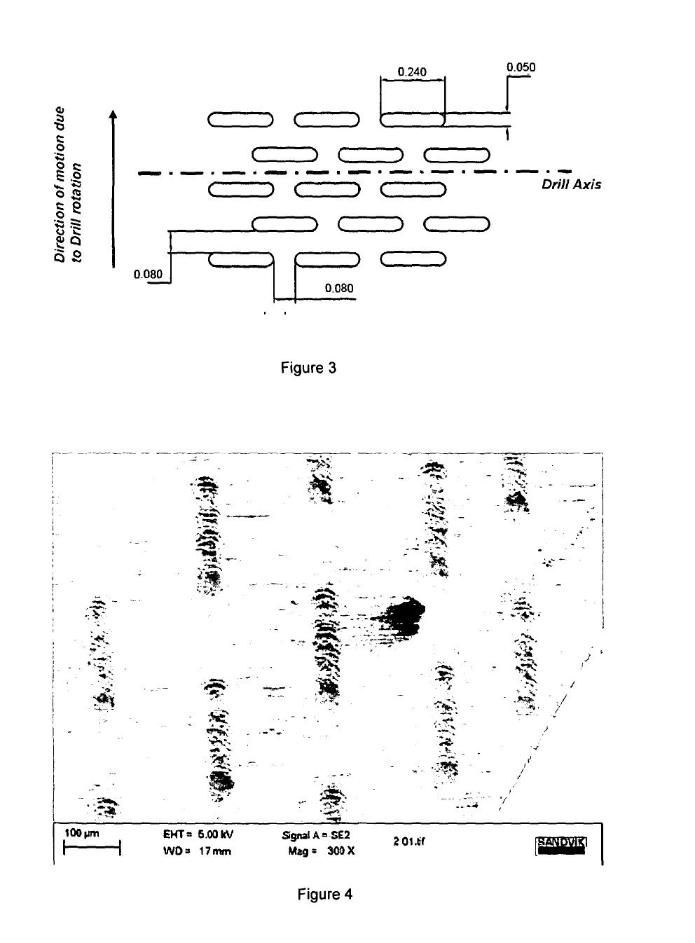

FIG. 3 shows a pattern of pits applied to a tool blank, the pits having an elongate “slot” shape;

FIG. 4 shows an SEM image of a cylindrical land of a twist drill comprising an array of pits;

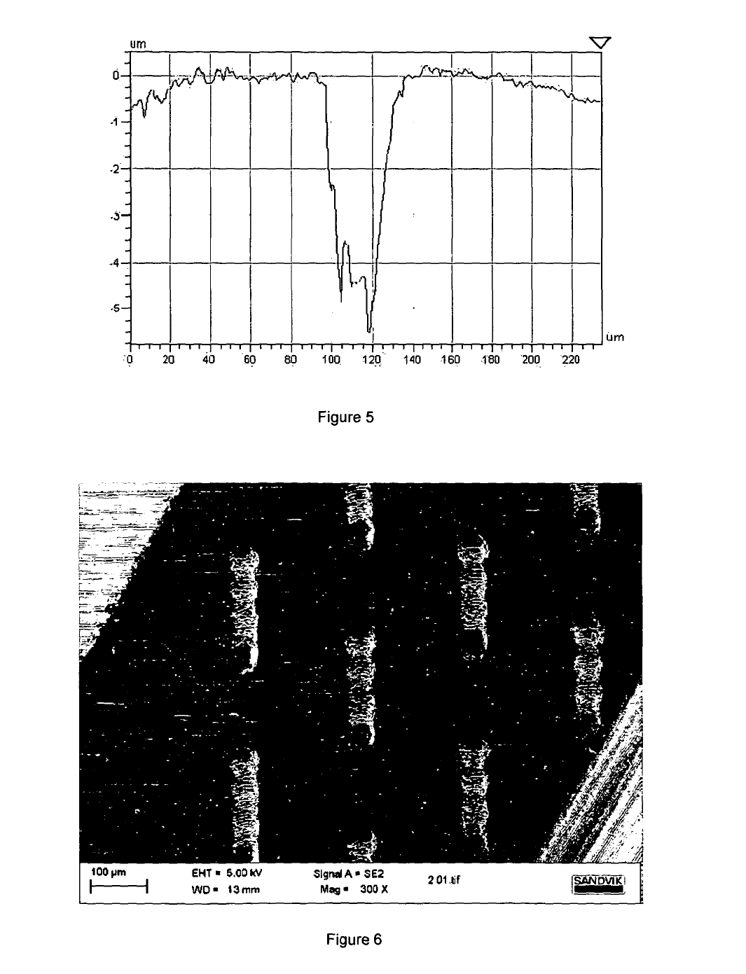

FIG. 5 shows the results of white light analysis (using a Wyko white light interferometer) of a pit presented as a cross-section or profile in the width direction (short axis of the pit);

FIG. 6 shows an SEM image of pits after coating with TiAlN; and

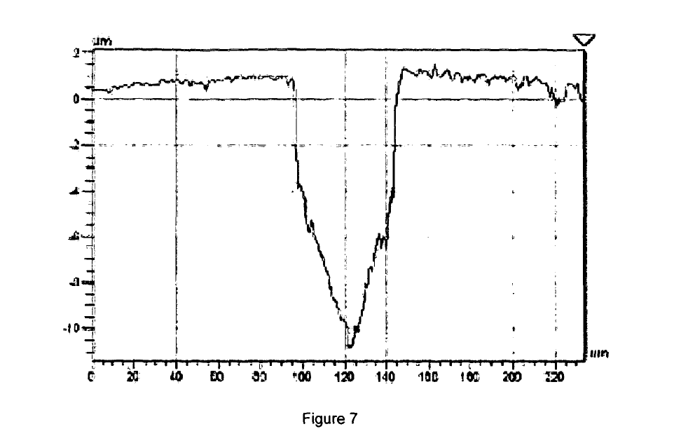

FIG. 7 shows the results of white light analysis (using a Wyko white light interferometer) of a pit presented as a cross-section or profile in the width direction (short axis of the pit).

For the avoidance of doubt, the term “pit” as used herein refers to a closed-end pore or blind hole. Preferred pit dimensions are described herein.

For the avoidance of doubt, the term “bore cutting tool” as used herein refers to a cutting tool adapted to cut a workpiece so as to form a bore, including reshaping or modifying an existing bore (whether or not other types of cutting or removal of workpiece material can also be performed by the tool). A preferred class of bore cutting tools is round tools. Preferred round tools include twist drills, end mills, reamers and taps. Twist drills are particularly preferred. Whilst any twist drill geometry can be used, a point angle of 90° to 180° is preferred.

For the avoidance of doubt, the term “array of pits” as used herein refers to a plurality of pits arranged in an ordered, regular or non-random pattern. An example of an array of pits is a plurality of rows of pits, with substantially equal spacing between adjacent pits and respective rows.

FIG. 1 illustrates a cross-section taken at the surface portion of a bore cutting tool 2 according to the present invention. The tool substrate 4 is provided with a pit 6, for example by laser etching. A tool coating 8 is then applied to the pitted tool substrate. The tool coating follows the contour of the pit so that the surface of the pit 10 comprises tool coating. The resultant pit has a comparatively smooth and homogenous surface. There is a smooth transition from the substantially flat main surface of the tool and the “inner” surface of the pit. When the bore cutting tool is provided with a plurality of such pits, the tool is adapted to work efficiently with lubricant (for example MQL) by retaining lubricant in the pits.

### EXAMPLES AND TESTING

### Example 1

A tungsten carbide rod was machined so as to produce a twist drill blank having a diameter of 12 mm. The blank was provided with an ordered pattern (array) of pits in the surface of the blank corresponding to the drill body, by laser etching. The area to which the pattern was applied is shown in FIG. 2. The pattern applied to the blank is shown in FIG. 3. The pattern comprises “slot” shaped elongate pits arranged with their longer axis parallel to the main longitudinal axis of the drill (perpendicular to the direction of drill rotation). The pit density was programmed to be about 24 pits/mm².

SEM analysis indicated that burr or flash was present around the periphery of the pits. The blanks were therefore surface cleaned using an outer diameter grind to remove the flash. The resultant pits in the tool blank surface are shown in FIG. 4, which illustrates that substantially no flash remains.

The absence of flash was confirmed by white light interferometry using a Wyko white light analyser. White light analysis permits imaging of the 3D surface of the tool. From the acquired data, cross-sections or profiles of the pits can be viewed and measurements of pit depth (at deepest point), width (at widest point) and length (at longest point) can be made, as well as cross-sectional area (at surface). An example of a pit profile across the short axis (width) of the pit is shown in FIG. 4.

The tool blank was then machined so as to produce a drill geometry corresponding to Dormer Tools' CDX R553 commercial product.

The cylindrical land is the only part of the twist drill that retains the pattern of pits. The rest of the surface of the tool blank is removed during the machining steps.

From SEM and white light analysis the following pit dimensions were obtained:

Average pit width=60 μm

Average pit depth=11 μm

Average pit length=230 μm

Average height of flash=0 μm

Pit spacing was selected by appropriate programming of the laser apparatus: approx 320 μm (centre to centre in length direction) and approx 130 μm (centre to centre in width direction). Other centre to centre spacings are possible, for example 100 μm to 200 μm.

The twist drill was then coated with TiAlN using a standard deposition technique. The depth of TiAlN coating on the tool substrate was about 1 μm. The coating was applied to all of the twist drill, including the cylindrical land. The coating extends over the pits so that, in cross-section, the tool comprises pits in the tool substrate with a layer of TiAlN following the contour of the pit (e.g. as illustrated in FIG. 1). Other coatings can be used instead of TiAlN.

The coated pits are shown in FIG. 5. A white light analysis width profile of a pit after coating is shown in FIG. 6.

From SEM and white light analysis after coating the following pit dimensions were obtained:

Average pit width=60 μm

Average pit depth=9 μm

Average pit length=230 μm

Average height of flash=0 μm

### Example 2

The same procedure as Example 1 was followed except that the laser dwelling time was slightly longer during the laser texturing step.

After coating, the average pit width was measured as 50 μm, the average pit length 220 μm and the average pit depth 11 μm.

### Comparative Example 1

A twist drill without pits was made in the same way as Example 1 except laser texturing was not applied.

Tests

Examples 1 and 2 and Comparative Example 1 were tested using two workpiece materials: AMG 1.5 (steel alloy) and AMG 4.3 (Titanium alloy). AMG 4.3 is particularly demanding because drilling of Ti workpieces is known to generate high temperatures and can even cause combustion of the Ti.

The following conditions and settings were used in Test 1:

Machine: DMU-60

Material: AMG 1.5 (W No. 1.2312)

Drill geometry: R553

Diameter: 12.00 mm

Drill length: 5×diameter

Drill depth: 36 mm blind holes

Coating: TiAlN

Coolant: MQL

Number of holes: 10 holes per test per tool

Monitoring equipment: analySIS software and microscope, and Kistler Dynamometer (9123C 1011, with Dyno Wear Software) to monitor cutting thrust and torque.

Surface speed: 48 mm/min

Feed: 0.15 mm/rev

Spindle speed: 1273 rpm

Penetration rate: 190 mm/min

Once the holes were completed, the holes were measured using a Renishaw probe (MP700 OMP70) at depths of 10 mm and 30 mm.

The thrust force and torque measurements showed that twist drills comprising an array of pits on the cylindrical land experience acceptable levels of thrust and torque.

The hole size measurements (using the Renishaw probe) showed that both of Example 1 and Example 2 produced “tighter” holes than Comparative Example 1. Indeed, both examples achieved a mean hole tolerance of H7, whereas Comparative Example 1 achieved only H9 (ISO 286 “Limits and fits”).

Furthermore, good hole size reproducibility was also achieved.

The following conditions and settings were used in Test 2:

Machine: DMU-60

Material: AMG 4.3 (Ti-6 Al-4V)/ASTM 8265

Drill geometry: R553

Diameter: 12.00 mm

Drill length: 5×diameter

Drill depth: 14 mm through holes

Coating: TiAlN

Coolant: MQL

Number of holes: 3 holes per test per tool

Monitoring equipment: analySIS software and microscope and Kistler Dynamometer (to monitor cutting thrust and torque)

Surface speed: 25 mm/min

Feed: 0.135 mm/rev

Spindle speed: 663 rpm

Penetration rate: 90 mm/min

Once the holes were completed, the holes were measured using the Renishaw probe at depths of 5 mm and 10 mm.

The thrust force and torque measurements showed that twist drills comprising an array of pits on the cylindrical land experience acceptable levels of thrust and torque in the Ti workpiece. Indeed, the torque levels experienced in Ti were significantly lower for Examples 1 and 2 as compared to Comparative Example 1.

The hole size measurements (using the Renishaw probe) showed that both of Example 1 and Example 2 produced “tighter” holes than Comparative Example 1 when used in the Ti workpiece. Furthermore, particularly at a depth of 5mm, the spread of hole size is smaller for Examples 1 and 2 as compared to Comparative Example 1.

The consistent hole sizes achieved by the laser textured tools indicate that the laser textured tools are reducing the frictional properties of the tool. In particular, the excellent hole size spread at 5mm suggests that the work piece material begins to cool and restore its original shape, thus minimising the possibility of “snatching”. In particular, the reduction in the heat generation can reduce the extent of expansion of the workpiece material thus reducing the “closing in” of the hole on the tool, which effect can cause “grabbing” of “snatching” of the tool.

The test results demonstrate that excellent hole quality can be achieved, particularly in the case of a Ti workpiece.

Furthermore, especially in the case of the challenging Ti workpiece, a reduced torque value is experienced. This indicates that the tool is under less stress, potentially leading to improved tool life with concomitant improvements in tool productivity. The reduction in torque may also permit reduced power consumption, thus generating savings in machine overheads and of course benefitting the environment.

Furthermore, the results show that laser textured tools may be particularly suitable for use with minimum quantity lubrication (MQL) because they optimise the use of the comparatively small amounts of lubricant which are applied to the tool and workpiece in MQL. This permits a reduction in the environmental impact as a result of reduced waste lubricant and a reduction in the cost for the disposal or reclamation of lubricant.

1. A bore cutting tool comprising:
a tool substrate; and
a tool coating on a surface of the tool substrate wherein the bore cutting tool includes a plurality of pits in the surface of the tool substrate and wherein the tool coating extends over the plurality of pits such that the pit surface comprises the tool coating.

2. A bore cutting tool according to claim 1, wherein an average pit depth of each of the plurality of pits is at least 8 μm.

3. A bore cutting tool according to claim 1, wherein an average pit depth of each of the plurality of pits is about 8 μm to about 25 μm.

4. A bore cutting tool according to claim 1, wherein an average pit cross-sectional area of each of the plurality of pits is about 0.005 mm² to about 1 mm².

5. A bore cutting tool according to claim 1, wherein the plurality of pits is an array of pits.

6. A bore cutting tool according to claim 1, wherein the plurality of pits is present only on at least one surface of the bore cutting tool, which in use is in frictional contact with a workpiece.

7. A bore cutting tool according to claim 1, wherein the bore cutting tool is a twist drill having a cylindrical land and the plurality of pits is disposed only on the cylindrical land.

8. A bore cutting tool according to claim 1, wherein the tool coating has an average thickness of about 1 μm to about 5 μm.

9. A bore cutting tool according to claim 1, wherein the tool coating comprises TiAlN.

10. A bore cutting tool according to claim 1, wherein the plurality of pits is formed by laser etching or electron beam etching of the tool substrate prior to forming the tool coating.

11. A method of making a bore cutting tool having a plurality of pits on a surface of the bore cutting tool, the method comprising the steps of:
forming a plurality of pits in the surface of a tool substrate; and
coating the surface of the tool substrate to form a tool coating.

12. A method according to claim 11, wherein an average depth of each of the plurality of pits formed in the tool substrate is at least 8 μm.

13. A method according to claim 11, wherein an average depth of each of the plurality of pits formed in the tool substrate is about 8 μm to about 25 μm.

14. A method according to claim 11, wherein an average cross-sectional area of each of the plurality of pits formed in the tool substrate is about 0.005 mm² to about 1 mm².

15. A method according to claim 11, wherein the plurality of pits is an array of pits.

16. A method according to claim 11, wherein the bore cutting tool is a twist drill having a cylindrical land and the plurality of pits is disposed only on the cylindrical land.

17. A method according to claim 11, wherein the tool coating has an average thickness of about 1 μm to 5 μm.

18. A method according to claim 11, wherein the tool coating comprises TiAlN.

19. A method according to claim 11, wherein the plurality of pits is formed by laser etching or electron beam etching of the tool substrate.

20. A method according to claim 11, wherein the step of forming the plurality of pits comprises forming pits in a tool blank and machining the blank to form the tool substrate.

21. A method of making a bore cutting tool having a plurality of pits in a surface of the bore cutting tool, the method comprising the steps of:
forming the plurality of pits in a surface of a bore cutting tool blank; and
machining the blank to form the bore cutting tool.

22. A method according to claim 21, further comprising the step of coating the bore cutting tool to form a tool coating.

23. A method according to claim 21, wherein the bore cutting tool is a twist drill and the step of machining the blank includes machining at least one flute.

24. A method according to claim 21, wherein the bore cutting tool is a twist drill having a cylindrical land, and the step of machining the blank includes forming the cylindrical land, the cylindrical land having a plurality of pits.

25. A method according to claim 21, wherein the plurality of pits is formed by laser etching or electron beam etching of the blank.

26. A method of making a bore cutting tool having a plurality of pits in a surface of the bore cutting tool, the method comprising the steps of:
forming the plurality of pits using a laser or electron beam;
cleaning the surface of the bore cutting tool; and
forming an array of pits in the surface of the bore cutting tool.

27. (canceled)

28. (canceled)

29. A method according to claim 26, wherein the step of forming the array of pits includes forming the array of pits using a laser or electron beam.

30. A method according to claim 26, wherein the array of pits comprises a plurality of regularly spaced rows of pits.

31. A method according to claim 26, wherein an average pit depth of each of the plurality of pits is at least 8 μm.

32. A method according to claim 26, wherein an average pit depth of each of the plurality of pits is about 8 μm to about 25 μm.

33. A method according to claim 26, wherein an average pit cross-sectional area of each of the plurality of pits is of about 0.005 mm² to about 1 mm².

34. A bore cutting tool comprising:
an array of pits disposed in a surface of the bore cutting tool, wherein the array of pits are a plurality of regularly spaced rows of pits.

35. (canceled)

36. A bore cutting tool according to claim 34, wherein an average pit depth of each of the pits is at least 8 μm.

37. A bore cutting tool according to claim 34, wherein an average pit depth of each of the pits is of about 8 μm to about 25 μm.

38. A bore cutting tool according to claim 34, wherein an average pit cross-sectional area of each of the pits is of about 0.005 mm² to about 1 mm².
